(19) United States
(12) Patent Application Publication
(10) Pub. No.: US 2025/0101223 A1
(43) Pub. Date: Mar. 27, 2025

(54) POLYCARBONATE-BASED RESIN COMPOSITION

(71) Applicant: IDEMITSU KOSAN CO.,LTD., Tokyo (JP)

(72) Inventors: Takahiro BITO, Chiba-shi, Chiba (JP); Shuya NAGAYAMA, Chiba-shi, Chiba (JP); Junichi TSUZUKI, Sodegaura-shi,Chiba (JP)

(73) Assignee: IDEMITSU KOSAN CO.,LTD., Tokyo (JP)

(21) Appl. No.: 18/846,827

(22) PCT Filed: Mar. 13, 2023
(86) PCT No.: PCT/JP2023/009687

§ 371 Date: Sep. 13, 2024

(30) Foreign Application Priority Data
Mar. 14, 2022 (JP) 2022-039691

(51) Int. Cl. C08L 69/00; C08K 3/20; C08K 3/22; C08K 5/521; C08K 9/02; C08K 9/06

(52) U.S. Cl. CPC C08L 69/00; C08K 3/20; C08K 5/521; C08K 9/02; C08K 9/06; C08K 2003/2237; C08K 2201/005; C08K 2201/006; C08L 2207/322

(57) ABSTRACT

A polycarbonate-based resin composition including: an aromatic polycarbonate resin; inorganic particles; and a liquid oil component. The inorganic particles have an average particle diameter of from 0.1 μm to 1 μm. A content of the inorganic particles is from 0.00001 part by mass to 0.001 part by mass with respect to 100 parts by mass of the aromatic polycarbonate resin. When a part by mass of the inorganic particles with respect to 100 parts by mass of the aromatic polycarbonate resin is represented by m_{B}, a specific surface area of the inorganic particles is represented by S_{B} (m²/g), and a part by mass of the liquid oil component with respect to 100 parts by mass of the aromatic polycarbonate resin is represented by m_{C}, α determined by the following equation 1 is more than 0.005 and less than 0.1: Equation 1: α=(m_{B}×S_{B})/m_{C}.

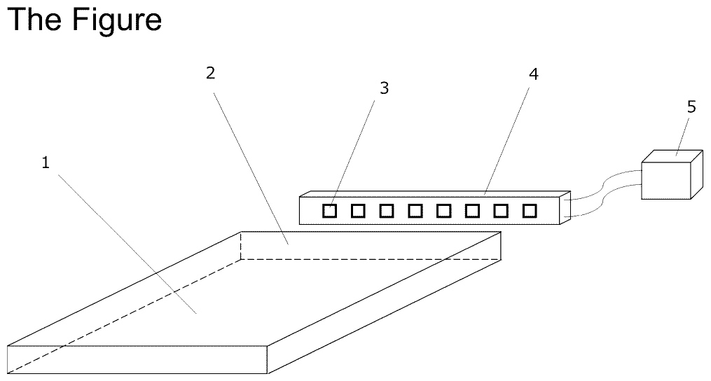

### CROSS-REFERENCE TO RELATED APPLICATIONS

The present application claims priority under 35 U.S.C. § 371 to International Patent Application No. PCT/JP2023/009687, filed Mar. 13, 2023, which claims priority to and the benefit of Japanese Patent Application No. 2022-039691, filed on Mar. 14, 2022. The contents of these applications are hereby incorporated by reference in their entireties.

### TECHNICAL FIELD

The present invention relates to a polycarbonate-based resin composition, a production method therefor, a pellet thereof, and a molded body thereof.

### BACKGROUND ART

An aromatic polycarbonate resin is excellent in, for example, transparency, mechanical properties, thermal properties, and electrical properties, and has been used in various optical molded articles, such as a light-guiding member, for example, a light-guiding plate, a lens, and an optical fiber, through utilization of its characteristics.

In recent years, a polycarbonate-based resin composition containing an aromatic polycarbonate resin has been applied to light-guiding parts such as inner lenses for forming the light-guiding portions of the daytime running lights (daytime running lights or daytime running lamps; hereinafter sometimes referred to as “DRL”) or various optical parts of vehicles, such as automobiles and motorcycles.

In a DRL application of the polycarbonate-based resin composition containing an aromatic polycarbonate resin, such performance that, when light is caused to enter from an end portion, uniform emission occurs in a surface direction (hereinafter referred to as “surface emitting property”) has been required from the viewpoint of a design property. In addition, in a material exhibiting the surface emitting property, increases in area and length have been proceeding as compared to the related-art molded article. A surface emitting material is liable to undergo a change in not only luminance but also color with an increase in light-guiding length. This results from occurrence of reflection and absorption of part of light in an inside of a molded body as compared to a transparent material. Even when the light-guiding length is slightly increased, the color is liable to change, and hence a material in which a change in not only luminance but also color is small has been required.

In some cases, the polycarbonate-based resin composition causes a silver streak on a surface of a molded body, and hence the appearance of the molded body becomes unsatisfactory. Recently, it has been required to suppress a material loss from the viewpoint of reducing an environmental load. In particular, a material that provides a molded body in which occurrence of a silver streak is suppressed at the time of molding, and which is excellent in appearance, has been required.

In PTL 1, there is a disclosure of a transparent resin composition containing a transparent resin and a specific amount of a light diffuser having an average particle diameter of 220 nm or more and 300 nm or less as a resin molded body excellent in transparency, luminance, low coloring property, and balance between transparency and luminance.

In PTL 2, as a polycarbonate resin composition that enables, for example, a light-guiding plate being excellent in total light transmittance and haze, having high luminance and a wide emission range, and having an extremely small number of bright spots, there is a disclosure of a polycarbonate resin composition containing specific amounts of a polycarbonate resin (A) and titanium oxide (B) having a specific number-average primary particle diameter and a specific number-average secondary particle diameter.

### CITATION LIST

### Patent Literature

PTL 1: WO 2019/172243 A1

PTL 2: JP 2020-7459 A

### SUMMARY OF INVENTION

### Technical Problem

However, in the related-art polycarbonate resin composition, a resin molded body obtained therefrom has not been sufficient in surface emitting characteristics relating to changes in luminance and color with the length of the light-guiding length.

An object of the present invention is to provide a polycarbonate-based resin composition that provides a resin molded body having a surface emitting property in which changes in luminance and color with the length of the light-guiding length are small, the resin molded body being excellent in appearance, a pellet thereof, and a molded body thereof.

### Solution to Problem

That is, the present invention relates to the following items [1] to [10].
[1] A polycarbonate-based resin composition, comprising: an aromatic polycarbonate resin (A); inorganic particles (B); and a liquid oil component (C),
wherein the inorganic particles (B) have an average particle diameter of from 0.1 μm to 1 μm,
wherein a content of the inorganic particles (B) is from 0.00001 part by mass to 0.001 part by mass with respect to 100 parts by mass of the aromatic polycarbonate resin (A), and
wherein, when a part by mass of the inorganic particles (B) with respect to 100 parts by mass of the aromatic polycarbonate resin (A) is represented by m_{B}, a specific surface area of the inorganic particles (B) is represented by S_{B} (m²/g), and a part by mass of the liquid oil component (C) with respect to 100 parts by mass of the aromatic polycarbonate resin (A) is represented by m_{C}, α determined by the following equation 1 is more than 0.005 and less than 0.1.

$$α = ( {m}_{B} \times {S}_{B} ) / {m}_{C} \qquad Equation 1$$

[2] The polycarbonate-based resin composition according to Item [1], wherein the inorganic particles (B) are titanium oxide.
[3] The polycarbonate-based resin composition according to Item [1] or [2], further comprising an antioxidant (D), wherein the antioxidant (D) contains at least one selected from the group consisting of: a phosphorus-based antioxidant; and a phenol-based antioxidant.
[4] The polycarbonate-based resin composition according to Item [3], wherein a content of the antioxidant (D) is from 0.001 part by mass to 1.0 part by mass with respect to 100 parts by mass of the aromatic polycarbonate resin (A).
[5] The polycarbonate-based resin composition according to Item [3] or [4], wherein, when a part by mass of the antioxidant (D) with respect to 100 parts by mass of the aromatic polycarbonate resin (A) is represented by m_{D}, β determined by the following equation 2 is more than 2.95 and less than 100:

$$β = {m}_{D} / ( {m}_{B} \times {S}_{B} ) \qquad Equation 2$$

wherein m_{B} and S_{B} are the same as those described above.
[6] The polycarbonate-based resin composition according to any one of Items [1] to [5], wherein the aromatic polycarbonate resin (A) has a viscosity-average molecular weight of from 12,500 to 30,500.
[7] The polycarbonate-based resin composition according to any one of Items [1] to [6], wherein the liquid oil component (C) contains at least one selected from the group consisting of: a paraffin-based process oil; a naphthene-based process oil; an aromatic process oil; and a silicone oil.
[8] The polycarbonate-based resin composition according to any one of Items [1] to [7], wherein the liquid oil component (C) is liquid at normal temperature, and has a kinematic viscosity at 40° C. of from 30 cSt to 1,000 cSt.
[9] A pellet, comprising the polycarbonate-based resin composition of any one of Items [1] to [8].
[10] A molded body, comprising the polycarbonate-based resin composition of any one of Items [1] to [8].

### Advantageous Effects of Invention

According to the present invention, the polycarbonate-based resin composition that provides a resin molded body having a uniform surface emitting property in which changes in luminance and color with the light-guiding length are small, the resin molded body being excellent in appearance, the pellet thereof, and the molded body thereof are provided.

### BRIEF DESCRIPTION OF DRAWINGS

The FIGURE is a schematic view of a measurement apparatus used in an optical evaluation in a surface direction.

### DESCRIPTION OF EMBODIMENTS

A polycarbonate-based resin composition, a production method therefor, a pellet thereof, and a molded body thereof of the present invention are described in detail below.

Herein, a specification considered to be preferred may be arbitrarily adopted, and a combination of preferred specifications can be said to be more preferred. The expression “XX to YY” as used herein means “XX or more and YY or less.”

### [Polycarbonate-Based Resin Composition]

The polycarbonate-based resin composition of the present invention is a polycarbonate-based resin composition comprising: an aromatic polycarbonate resin (A); inorganic particles (B); and a liquid oil component (C),
wherein the inorganic particles (B) have an average particle diameter of from 0.1 μm to 1 μm,
wherein a content of the inorganic particles (B) is from 0.00001 part by mass to 0.001 part by mass with respect to 100 parts by mass of the aromatic polycarbonate resin (A), and wherein, when a part by mass of the inorganic particles (B) with respect to 100 parts by mass of the aromatic polycarbonate resin (A) is represented by m_{B}, a specific surface area of the inorganic particles (B) is represented by S_{B} (m²/g), and a part by mass of the liquid oil component (C) with respect to 100 parts by mass of the aromatic polycarbonate resin (A) is represented by m_{C}, α determined by the following equation 1 is more than 0.005 and less than 0.1.

$$α = ( {m}_{B} \times {S}_{B} ) / {m}_{C} \qquad Equation 1$$

### [Aromatic Polycarbonate Resin (A)]

A resin produced by a known method may be used as the aromatic polycarbonate resin (A) in the polycarbonate-based resin composition of the present invention without any particular limitation.

For example, a resin produced by causing a dihydric phenol and a carbonate precursor to react with each other by a solution method (interfacial polycondensation method) or a melting method (ester exchange method), that is, a resin produced by the interfacial polycondensation method including causing the dihydric phenol and phosgene to react with each other in the presence of a terminal stopper, or by causing the dihydric phenol and diphenyl carbonate or the like to react with each other in the presence of the terminal stopper according to the ester exchange method or the like may be used as the aromatic polycarbonate resin (A).

Examples of the dihydric phenol include bis(hydroxyphenyl)alkane-based compounds, such as 2,2-bis(4-hydroxyphenyl) propane [bisphenol A], bis(4-hydroxyphenyl) methane, 1,1-bis(4-hydroxyphenyl) ethane, and 2,2-bis(4-hydroxy-3,5-dimethylphenyl) propane, 4,4′-dihydroxydiphenyl, a bis(4-hydroxyphenyl)cycloalkane, bis(4-hydroxyphenyl) oxide, bis(4-hydroxyphenyl) sulfide, bis(4-hydroxyphenyl) sulfone, bis(4-hydroxyphenyl) sulfoxide, bis(4-hydroxyphenyl) ketone, hydroquinone, resorcinol, and catechol. Those dihydric phenols may be used alone or in combination thereof.

Among them, bis(hydroxyphenyl)alkane-based compounds are preferred, 2,2-bis(4-hydroxyphenyl) propane [bisphenol A], bis(4-hydroxyphenyl) methane, and 1,1-bis(4-hydroxyphenyl) ethane are more preferred, and bisphenol A is particularly suitable.

Examples of the carbonate precursor include a carbonyl halide, a carbonyl ester, and a haloformate. Specific examples thereof include phosgene, a dihaloformate of a dihydric phenol, diphenyl carbonate, dimethyl carbonate, and diethyl carbonate.

The aromatic polycarbonate resin (A) may have a branched structure. Examples of a branching agent used for introducing the branched structure include 1,1,1-tris(4-hydroxyphenyl) ethane, α,α′,α″-tris(4-hydroxyphenyl)-1,3,5-triisopropylbenzene, phloroglucin, trimellitic acid, and 1,3-bis(o-cresol).

Examples of the terminal stopper include a monovalent carboxylic acid and a derivative thereof, and a monohydric phenol. Specific examples thereof include p-tert-butylphenol, p-phenylphenol, p-cumylphenol, p-perfluorononylphenol, p-(perfluorononylphenyl) phenol, p-(perfluorohexylphenyl) phenol, p-tert-perfluorobutylphenol, 1-(p-hydroxybenzyl) perfluorodecane, p-[2-(1H, 1H-perfluorotridodecyloxy)-1,1,1,3,3,3-hexafluoropropyl]phenol, 3,5-bis(perfluorohexyloxycarbonyl) phenol, perfluorododecyl p-hydroxybenzoate, p-(1H, 1H-perfluorooctyloxy) phenol, 2H,2H,9H-perfluorononanoic acid, and 1,1,1,3,3,3-hexafluoro-2-propanol.

It is preferred that the aromatic polycarbonate resin (A) be a polycarbonate resin including, in a main chain thereof, a repeating unit represented by the following general formula (I):

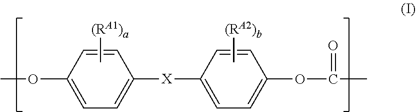

wherein R^{A1} and R^{A2} each represent an alkyl group or alkoxy group having 1 or more and 6 or less carbon atoms, and R^{A1} and R^{A2} may be identical to or different from each other, X represents a single bond, an alkylene group having 1 or more and 8 or less carbon atoms, an alkylidene group having 2 or more and 8 or less carbon atoms, a cycloalkylene group having 5 or more and 15 or less carbon atoms, a cycloalkylidene group having 5 or more and 15 or less carbon atoms, —S—, —SO—, —SO₂—, —O—, or —CO—, and “a” and “b” each independently represent an integer of 0 or more and 4 or less, when “a” represents 2 or more, R^{A1}s may be identical to or different from each other, and when “b” represents 2 or more, R^{A2}s may be identical to or different from each other.

Examples of the alkyl group represented by each of R^{A1} and R^{A2} include a methyl group, an ethyl group, a n-propyl group, an isopropyl group, various butyl groups (the term “various” means that a linear group and various branched groups are included, and the same holds true for the following), various pentyl groups, and various hexyl groups. An example of the alkoxy group represented by each of R^{A1} and R^{A2} is an alkoxy group having the alkyl group as an alkyl group moiety.

R^{A1} and R^{A2} each preferably represent an alkyl group having 1 or more and 4 or less carbon atoms or an alkoxy group having 1 or more and 4 or less carbon atoms.

Examples of the alkylene group represented by X include a methylene group, an ethylene group, a trimethylene group, a tetramethylene group, and a hexamethylene group. Among them, an alkylene group having 1 or more and 5 or less carbon atoms is preferred. Examples of the alkylidene group represented by X include an ethylidene group and an isopropylidene group. Examples of the cycloalkylene group represented by X include a cyclopentanediyl group, a cyclohexanediyl group, and a cyclooctanediyl group. Among them, a cycloalkylene group having 5 or more and 10 or less carbon atoms is preferred. Examples of the cycloalkylidene group represented by X include a cyclohexylidene group, a 3,5,5-trimethylcyclohexylidene group, and a 2-adamantylidene group. Among them, a cycloalkylidene group having 5 or more and 10 or less carbon atoms is preferred, and a cycloalkylidene group having 5 or more and 8 or less carbon atoms is more preferred.

“a” and “b” each represent preferably 0 or more and 2 or less, more preferably 0 or 1.

The aromatic polycarbonate resin (A) preferably contains a polycarbonate resin having a bisphenol A structure from the viewpoints of, for example, the transparency, mechanical characteristics, and thermal characteristics of a molded body to be obtained. The polycarbonate resin having a bisphenol A structure is specifically, for example, such a resin that X in the general formula (I) represents an isopropylidene group. The content of the polycarbonate resin having a bisphenol A structure in the aromatic polycarbonate resin (A) is preferably 50 mass % or more and 100 mass % or less, more preferably 75 mass % or more and 100 mass % or less, still more preferably 85 mass % or more and 100 mass % or less.

The viscosity-average molecular weight (Mv) of the aromatic polycarbonate resin (A) may be from 12,500 to 30,500. From the viewpoint of sufficiently increasing the strength of the molded body, the Mv is preferably 13,000 or more, more preferably 13,500 or more, still more preferably 14,000 or more. In addition, from the viewpoint of sufficiently increasing the fluidity of the resin for molding, the Mv is preferably 30,500 or less, more preferably 25,000 or less, still more preferably 22,000 or less. That is, when the Mv is from 12,500 to 30,500, the aromatic polycarbonate resin (A) can achieve both of more sufficiently high fluidity and more sufficiently high strength of the molded body.

The viscosity-average molecular weight (Mv) as used herein is calculated from the following equation after the determination of a limiting viscosity [η] through the measurement of the viscosity of a methylene chloride solution at 20° C. with an Ubbelohde-type viscometer.

$$[ η ] = 1.23 \times {10}^{- 5} {Mv}^{0.83}$$

### [Inorganic Particles (B)]

The polycarbonate-based resin composition of the present invention comprises the inorganic particles (B) having an average particle diameter of from 0.1 μm to 1 μm as a component for diffusing incident light.

The inorganic particles (B) are not particularly limited as long as the component can diffuse incident light, and known inorganic particles, such as titanium oxide, aluminum oxide, zinc oxide, zinc sulfide, and barium sulfate, may be used. Among them, titanium oxide is preferred from the viewpoint of a uniform surface emitting property. It is conceived that titanium oxide has excellent light-diffusing performance of particles themselves, and hence a uniform surface emitting property can be efficiently achieved. The inorganic particles (B) may be used alone or in combination thereof.

When the inorganic particles (B) are titanium oxide, any one of a rutile-type structure and an anatase-type structure may be used as the crystal structure thereof, and titanium oxide having a rutile-type structure is preferred from the viewpoints of, for example, the thermal stability and light resistance of the polycarbonate-based resin composition.

The average particle diameter of the inorganic particles (B) is preferably 0.10 μm or more, more preferably 0.15 μm or more, still more preferably 0.23 μm or more from the viewpoint of suppressing a change in color with a light-guiding length when light is caused to enter a molded article, and is preferably 1.00 μm or less, more preferably 0.50 μm or less, still more preferably 0.30 μm or less from the viewpoint of the dispersibility of the inorganic particles. It is conceived that, when the average particle diameter of the inorganic particles (B) falls within the preferred ranges, the diffusion performance per particle of the inorganic particles (B) is improved to increase the dispersibility. The average particle diameter is a 50% cumulative particle diameter (D₅₀), and is measured by a method described in Examples.

The BET specific surface area of the inorganic particles (B) is preferably 1.44 m²/g or more, more preferably 2.88 m²/g or more, still more preferably 4.80 m²/g or more from the viewpoint of the dispersibility of the inorganic particles, and is preferably 14.4 m²/g or less, more preferably 9.59 m²/g or less, still more preferably 6.26 m²/g or less from the viewpoint of suppressing a change in color tone of the molded body. It is conceived that, when the BET specific surface area of the inorganic particles (B) is equal to or more than the preferred values, the cohesive strength of the inorganic particles (B) is suppressed, and as a result, the dispersibility is improved. In addition, it is conceived that, when the BET specific surface area of the inorganic particles (B) is equal to or less than the preferred values, an interface between the surface of each of the inorganic particles (B) and the aromatic polycarbonate resin (A) serving as a base polymer is reduced, and deterioration of the aromatic polycarbonate resin (A) is suppressed, and hence a change in color tone of the molded body can be suppressed.

The inorganic particles (B) are preferably inorganic particles subjected to surface treatment from the viewpoint of dispersibility in the molded body. Examples of the kind of the surface treatment include silicon dioxide (silica), zirconium oxide (zirconia), and aluminum hydroxide. The surface treatment preferably includes at least one selected from the group consisting of: silicon dioxide (silica); zirconium oxide (zirconia); and aluminum hydroxide, and more preferably includes aluminum hydroxide.

The inorganic particles are more preferably titanium oxide subjected to surface treatment.

The content of the inorganic particles (B) in the polycarbonate-based resin composition is preferably 0.00001 part by mass or more, more preferably 0.00005 part by mass or more, still more preferably 0.0001 part by mass or more, still more preferably 0.0003 part by mass or more with respect to 100 parts by mass of the aromatic polycarbonate resin (A) from the viewpoint of improving the luminance of the molded body in a surface direction, and is preferably 0.001 part by mass or less, more preferably 0.0009 part by mass or less, still more preferably 0.0008 part by mass or less, still more preferably 0.0006 part by mass or less with respect thereto from the viewpoint of a uniform surface emitting property. It is conceived that, when the content of the inorganic particles (B) is equal to or more than the preferred values, the diffusion performance of light is improved, and hence the luminance in the surface direction is increased. In addition, it is conceived that, when the content of the inorganic particles (B) is equal to or less than the preferred values, a change in luminance with the light-guiding length is suppressed, and hence a uniform surface emitting property can be maintained.

### [Liquid Oil Component (C)]

The polycarbonate-based resin composition of the present invention comprises the liquid oil component (C) from the viewpoint of improving the dispersibility of the inorganic particles (B).

Examples of the liquid oil component (C) include a paraffin-based process oil (liquid paraffin), a naphthene-based process oil, an aromatic process oil, and a silicone oil, which are liquid at normal temperature. The liquid oil components (C) may be used alone or in combination thereof.

Among them, a paraffin-based process oil, a naphthene-based process oil, an aromatic process oil, and a silicone oil are preferred from the viewpoint of availability, a paraffin-based process oil (liquid paraffin) and a silicone oil are more preferred from the viewpoint that any viscosity may be selected, and a silicone oil is still more preferred because a change in color tone at the time of the addition to the resin is small.

Examples of commercially available products of the paraffin-based process oil include “Diana Process Oil PW-32”, “Diana Process Oil PW-90”, “Diana Process Oil PW-150”, “Diana Process Oil PW-380”, “Diana Process Oil PS-32”, “Diana Process Oil PS-90”, and “Diana Process Oil PS-430” (product names, manufactured by Idemitsu Kosan Co., Ltd.), “Kaydol Oil” and “ParaLux Oil” (product names, manufactured by Chevron USA Inc.), and “Ragalrez 101” (product name, manufactured by Eastman Chemical Company).

Examples of commercially available products of the naphthene-based process oil include “Diana Process Oil NS-1000”, “Diana Process Oil NS-90S”, and “Diana Process Oil NR-26”, and “Diana Process Oil NM-280” (product names, manufactured by Idemitsu Kosan Co., Ltd.).

Examples of commercially available products of the aromatic process oil include “Diana Process Oil AC-12”, “Diana Process Oil AC-460”, and “Diana Process Oil NP-250”, and “Diana Process Oil AH-16” (product names, manufactured by Idemitsu Kosan Co., Ltd.).

Examples of a polysiloxane-based silicone oil include a dimethyl silicone oil, a phenylmethyl silicone oil, a diphenyl silicone oil, and a fluorinated alkyl silicone.

Examples of commercially available products of the silicone oil include a “KF-96” series and a “KR-510” (product names, manufactured by Shin-Etsu Chemical Co., Ltd.), and “DOWSIL SH-510 Fluid” and “DOWSIL FS-1265 Fluid” (product names, manufactured by Dow Toray Co., Ltd.).

For example, the liquid oil component (C) may be liquid at normal temperature, and have a kinematic viscosity at 40° C. of from 5 cSt to 1,000 cSt. It is preferred that the liquid oil component (C) be liquid at normal temperature, and have a kinematic viscosity at 40° C. of from 30 cSt to 1,000 cSt. The kinematic viscosity at 40° C. is more preferably from 30 cSt to 500 cSt, still more preferably from 50 cSt to 350 cSt. The kinematic viscosity of the liquid oil component (C) at 40° C. is preferably 30 cSt or more, more preferably 50 cSt or more, still more preferably 60 cSt or more, still more preferably 70 cSt or more, and is preferably 500 cSt or less, more preferably 350 cSt or less, still more preferably 200 cSt or less, still more preferably 150 cSt or less, from the viewpoint of improving the dispersibility of the inorganic particles (B). It is conceived that, when the kinematic viscosity of the liquid oil component (C) at 40° C. is equal to or more than the preferred values, the inorganic particles (B) are satisfactorily dispersed in the liquid oil component (C) without causing sedimentation. In addition, it is conceived that, when the kinematic viscosity is equal to or less than the preferred values, the surface of each of the inorganic particles (B) is satisfactorily coated with the liquid oil component (C), and hence the inorganic particles (B) are dispersed in the liquid oil component (C) without causing aggregation.

The kinematic viscosity at 40° C. is measured in conformity with JIS K 2283:2000.

The content of the liquid oil component (C) in the polycarbonate-based resin composition is preferably 0.005 part by mass or more, more preferably 0.01 part by mass or more, still more preferably 0.03 part by mass or more, still more preferably 0.05 part by mass or more with respect to 100 parts by mass of the aromatic polycarbonate resin (A) from the viewpoint of the dispersibility of the inorganic particles, and is preferably 0.5 part by mass or less, more preferably 0.4 part by mass or less, still more preferably 0.3 part by mass or less, still more preferably 0.2 part by mass or less with respect thereto from the viewpoint of suppressing the occurrence of a silver streak on the molded body. It is conceived that, when the content of the liquid oil component (C) is equal to or more than the preferred values, the liquid oil component (C) is mixed in a sufficient amount with respect to the addition amount of the inorganic particles (B), and hence the inorganic particles (B) are satisfactorily dispersed in the liquid oil component (C).

### [Antioxidant (D)]

The polycarbonate-based resin composition of the present invention preferably further comprises an antioxidant (D) from the viewpoint of preventing its coloring and the like due to the oxidative deterioration of the resin. The antioxidant (D) preferably contains at least one selected from the group consisting of: a phosphorus-based antioxidant; and a phenol-based antioxidant. The antioxidants (D) may be used alone or in combination thereof.

The phosphorus-based antioxidant is preferably a phosphite-based antioxidant and a phosphine-based antioxidant from the viewpoint of obtaining a resin composition that can be suppressed from causing discoloration and the like even when retained at high temperature.

Examples of the phosphite-based antioxidant include trisnonylphenyl phosphite, triphenyl phosphite, tridecyl phosphite, trioctadecyl phosphite, tris(2,4-di-tert-butylphenyl) phosphite (e.g., product available under the product name “Irgafos 168” from BASF SE or product available under the product name “ADK STAB 2112” from ADEKA Corporation), bis-(2,4-di-tert-butylphenyl) pentaerythritol-diphosphite (e.g., product available under the product name “Irgafos 126” from BASF SE or product available under the product name “ADK STAB PEP-24G” from ADEKA Corporation), bis-(2,4-di-tert-butyl-6-methylphenyl)ethyl phosphite (e.g., product available under the product name “Irgafos 38” from BASF SE), bis-(2,6-di-tert-butyl-4-methylphenyl) pentaerythritol-diphosphite (e.g., product available under the product name “ADK STAB PEP-36” from ADEKA Corporation), distearyl-pentaerythritol-diphosphite (e.g., product available under the product name “ADK STAB PEP-8” from ADEKA Corporation or product available under the product name “JPP-2000” from Johoku Chemical Co., Ltd.), [bis(2,4-di-tert-butyl-5-methylphenoxy)phosphino] biphenyl (e.g., product available under the product name “GSY-P101” from Osaki Industry Co., Ltd.), 2-tert-butyl-6-methyl-4-[3-(2,4,8,10-tetra-tert-butylbenzo[d] [1,3,2] benzodioxaphosphepin-6-yl)oxypropyl] phenol (e.g., product available under the product name “Sumilizer GP” from Sumitomo Chemical Company, Limited), tris[2-[[2,4,8,10-tetra-tert-butyldibenzo[d,f] [1,3,2] dioxaphosphepin-6-yl] oxy] ethyl]amine (e.g., product available under the product name “Irgafos 12” from BASF SE), and bis(2,4-dicumylphenyl) pentaerythritol diphosphite (product available under the product name “Doverphos S-9228PC” from Dover Chemical Corporation).

Among those phosphite-based antioxidants, tris(2,4-di-tert-butylphenyl) phosphite (“Irgafos 168”), bis(2,6-di-tert-butyl-4-methylphenyl) pentaerythritol-diphosphite (“ADK STAB PEP-36”), bis(2,4-di-tert-butylphenyl) pentaerythritol-diphosphite, bis(2,4-dicumylphenyl) pentaerythritol diphosphite (“Doverphos S-9228PC”), and 2-tert-butyl-6-methyl-4-[3-(2,4,8,10-tetra-tert-butylbenzo[d] [1,3,2] benzodioxaphosphepin-6-yl)oxypropyl] phenol (e.g., product available under the product name “Sumilizer GP”) are preferred from the viewpoint of preventing the coloring and the like of the resin composition. Bis(2,6-di-tert-butyl-4-methylphenyl) pentaerythritol-diphosphite (“ADK STAB PEP-36”) is particularly preferred.

An example of the phosphine-based antioxidant is triphenylphosphine (product available under the product name “JC263” from Johoku Chemical Co., Ltd.).

Examples of the phenol-based antioxidant include hindered phenols, such as n-octadecyl-3-(3,5-di-tert-butyl-4-hydroxyphenyl) propionate, 2,6-di-tert-butyl-4-methylphenol, 2,2′-methylenebis(4-methyl-6-tert-butylphenol), and pentaerythrityl-tetrakis[3-(3,5-di-tert-butyl-4-hydroxyphenyl) propionate].

Examples of commercially available products of the phenol-based antioxidant may include products available under the product names “Irganox 1010”, “Irganox 1076”, “Irganox 1330”, “Irganox 3114”, and “Irganox 3125” from BASF SE, a product available under the product name “BHT” from Takeda Pharmaceutical Company Limited, a product available under the product name “Cyanox 1790” from Cyanamid, and a product available under the product name “Sumilizer GA-80” from Sumitomo Chemical Company, Limited.

The content of the antioxidant (D) in the polycarbonate-based resin composition of the present invention may be from 0.001 part by mass to 1.0 part by mass with respect to 100 parts by mass of the aromatic polycarbonate resin (A). The content is preferably 0.001 or more, more preferably 0.005 or more, more preferably 0.01 or more, still more preferably 0.05 or more from the viewpoint of suppressing, for example, the coloring of the resin composition, and is preferably 0.5 or less, more preferably 0.2 or less, still more preferably 0.1 or less from the viewpoint of economic efficiency.

It is conceived that, when the content of the antioxidant (D) is equal to or more than the preferred values, the coloring due to the oxidative deterioration of the resin can be suppressed. In addition, when the content is equal to or less than the preferred values, the usage amount of the antioxidant (D), which tends to be expensive, becomes an appropriate amount, leading to an improvement in economic efficiency, and there is a tendency that the occurrence of die adhering matter, which is of concern when an excessive amount of the antioxidant is used at the time of the molding of the resin composition, is suppressed.

### [Other Additive]

The polycarbonate-based resin composition of the present invention may further comprise any other additive to the extent that the effects of the present invention are not impaired. Examples of the other component may include a releasing agent, a hydrolysis-resistant agent, a UV absorber, a flame retardant, a flame retardant aid, a reinforcing material, a filler, an elastomer for an impact resistance improvement, a pigment, and a dye.

### [Physical Properties of Polycarbonate-Based Resin Composition]

In the polycarbonate-based resin composition of the present invention, when the part by mass of the inorganic particles (B) with respect to 100 parts by mass of the aromatic polycarbonate resin (A) is represented by m_{B}, the specific surface area of the inorganic particles (B) is represented by S_{B} (m²/g), and the part by mass of the liquid oil component (C) with respect to 100 parts by mass of the aromatic polycarbonate resin (A) is represented by m_{C}, α determined by the following equation 1 is more than 0.005 and less than 0.1.

$$α = ( {m}_{B} \times {S}_{B} ) / {m}_{C} \qquad Equation 1$$

α represents a ratio of a product of m_{B} and S_{B} with respect to m_{C}.

α is preferably 0.005 m²/g or more, more preferably 0.010 m²/g or more, still more preferably 0.015 m²/g or more from the viewpoint of obtaining a uniform surface emitting property, and is preferably 0.1 m²/g or less, more preferably 0.08 m²/g or less, still more preferably 0.06 m²/g or less from the viewpoint of improving the color tone and appearance of the molded body. It is conceived that, when the liquid oil component (C) is mixed in a sufficient amount with respect to the total surface area of the inorganic particles (B), the inorganic particles (B) are satisfactorily dispersed. In addition, it is conceived that, when the usage amount of the liquid oil component (C) is not excessive with respect to the total surface area of the inorganic particles (B), the color tone deterioration of the molded body and the occurrence of a silver streak thereon are suppressed. From those viewpoints, a preferably falls within the range of the above-mentioned values.

In the case where the polycarbonate-based resin composition of the present invention comprises the antioxidant (D), when the part by mass of the antioxidant (D) with respect to 100 parts by mass of the aromatic polycarbonate resin (A) is represented by m_{D}, the part by mass of the inorganic particles (B) with respect to 100 parts by mass of the aromatic polycarbonate resin (A) is represented by m_{B}, and the specific surface area of the inorganic particles (B) is represented by S_{B} (m²/g), β determined by the following equation 2 may be, for example, more than 1.5 and less than 200. β is preferably more than 2.95 and less than 100, more preferably more than 2.95 and less than 200, still more preferably more than 2.95 and less than 100, still more preferably more than 3 and less than 60.

$$β = {m}_{D} / ( {m}_{B} \times {S}_{B} ) \qquad Equation 2$$

wherein m_{B} and S_{B} are the same as those described above.

β represents a ratio of m_{D} with respect to a product of m_{B} and S_{B}.

β is preferably more than 1.5, more preferably more than 2.95, still more preferably 3 or more, still more preferably more than 3, still more preferably 4 or more, still more preferably 5 or more from the viewpoint of suppressing the change in color tone of the molded body, and is preferably less than 200, more preferably less than 100, still more preferably 60 or less, still more preferably less than 60, still more preferably 30 or less, still more preferably 15 or less from the viewpoint of economic efficiency. It is conceived that, when β is equal to or more than the preferred values, the amount of the antioxidant (D) with respect to an interface between an active point of the surface of each of the inorganic particles (B) and the aromatic polycarbonate resin (A) serving as the base polymer becomes sufficient, and hence the change in color tone caused by the deterioration of the aromatic polycarbonate resin (A) is suppressed. In addition, when β falls is equal to or less than the preferred values, the usage amount of the antioxidant (D), which tends to be expensive, with respect to the interface between each of the inorganic particles (B) serving as the active point and the aromatic polycarbonate resin (A) serving as the base polymer becomes an appropriate amount.

The molded article of the polycarbonate-based resin composition of the present invention has a certain degree of luminance regardless of the length of the light-guiding length. That is, the molded article has a uniform surface emitting property.

Luminances at different lengths of the light-guiding length may be evaluated by measuring a surface emission luminance at a portion near a light source (for example, a light-guiding length of 25 mm) and a surface emission luminance at a portion far from the light source (for example, a light-guiding length of 125 mm). The luminance is typically represented in luminance [unit: cd/m²].

The molded article of the polycarbonate-based resin composition of the present invention has a small change in color with the length of the light-guiding length, and hence has an excellent degree of color uniformity.

The degree of color uniformity is determined by the following equation 3 when a “y” value in a CIE 1931 color space is measured in the molded article under the condition of a measurement angle of 1°, and measured values at light-guiding lengths of 125 mm and 75 mm are represented by y₁₂₅ and y₇₅, respectively. γ determined by the following equation 3 is preferably less than 1.1, more preferably less than 1.08, still more preferably less than 1.06, still more preferably less than 1.05.

$$γ = {y}_{125} / {y}_{75} \qquad Equation 3$$

γ represents a ratio of y₁₂₅ with respect to y₇₅.

γ becomes 1.0 in the case where a light-guiding color tone shows no change when the light-guiding length is changed, and the degree of color uniformity becomes more excellent as the value becomes closer to the above-mentioned value.

### [Method of Producing Polycarbonate-Based Resin Composition]

A method of producing the polycarbonate-based resin composition of the present invention is not particularly limited.

The polycarbonate-based resin composition may be produced by mixing the aromatic polycarbonate resin (A), the inorganic particles (B), and the liquid oil component (C), and the antioxidant (D) and any other additive as required in any order, and melting and kneading the mixture.

The melting and kneading may be performed by a typically used method, for example, a method including using a single-screw extruder, a twin-screw extruder, a co-kneader, a multiple-screw extruder, or the like. Among them, a method including using a twin-screw extruder is preferred from the viewpoints of, for example, productivity and general versatility.

A heating temperature at the time of the melting and kneading is preferably 200° C. or more, more preferably 220° C. or more, still more preferably 240° C. or more from the viewpoint of the dispersibility of the inorganic particles (B), and is preferably 300° C. or less, more preferably 290° C. or less, still more preferably 280° C. or less from the viewpoint of suppressing the coloring of the molded body. It is conceived that, when the heating temperature at the time of the melting and kneading is equal to or more than the preferred values, the viscosity of the aromatic polycarbonate resin (A) is increased, and hence the inorganic particles (B) are satisfactorily dispersed at the time of the kneading. In addition, it is conceived that, when the heating temperature is equal to or less than the preferred values, the deterioration of the aromatic polycarbonate resin (A) by heat is suppressed, and hence the coloring of the molded body is suppressed.

A retention time is preferably adjusted to 10 minutes or less. In addition, it is preferred that a screw include reverse screw elements or kneading discs at at least one or more portions, and the melting and kneading be performed while part of the components are retained at the portions.

In the method of producing the polycarbonate-based resin composition of the present invention, it is preferred that the inorganic particles (B) be mixed with any other component after being mixed with the liquid oil component (C) in advance.

At this time, it is preferred that the inorganic particles (B) be dispersed in the liquid oil component (C). For example, an ultrasonic oscillator and an ultrasonic transducer may be used for the dispersion of the inorganic particles (B). From the viewpoint of the dispersibility of the inorganic particles (B), the set frequency of an apparatus, such as an ultrasonic oscillator or an ultrasonic transducer, is preferably 3 kHz or more, more preferably 4 kHz or more, still more preferably 5 kHz or more, and is preferably 1,000 kHz or less, more preferably 400 kHz or less, still more preferably 100 kHz or less. When the frequency is equal to or more than the preferred values, the dispersion of fine particles is promoted. In addition, when the frequency is equal to or less than the preferred values, the inorganic particles (B) in the liquid oil component (C), which is viscous, can be efficiently dispersed with a high physical impact force.

An ultrasonic treatment time is preferably 3 minutes or more, more preferably 4 minutes or more, still more preferably 5 minutes or more from the viewpoint of the dispersibility of the inorganic particles (B) in the liquid oil component (C), and is preferably 30 minutes or less, more preferably 15 minutes or less, still more preferably 30 minutes or less from the viewpoint of mass productivity. When the ultrasonic treatment time is equal to or less than the preferred values, a working time can be shortened to secure the mass productivity.

### [Pellet and Molded Body]

The pellet of the present invention may be obtained through the melting and kneading in the above-mentioned production method. A method for pelletization is not particularly limited, and an example thereof is a method including cooling a melt-kneaded product and cutting the resultant. Specific examples thereof include a hot cutting method, a strand cutting method, and an underwater cutting method.

From the viewpoint of the stability of plasticization and metering at the time of molding, a mass per 50 pellets is preferably 0.3 g or more, more preferably 0.4 g or more, still more preferably 0.5 g or more, and is preferably 3.0 g or less, more preferably 1.8 g or less, still more preferably 1.5 g or less. When the mass per 50 pellets is equal to or more than the preferred values, a certain amount of the pellets are fed into a molding machine to be uniformly plasticized in a cylinder, and hence the stability at the time of molding is maintained.

The molded body of the present invention may be produced through use of a melt-kneaded product of the polycarbonate-based resin composition or the pellet as a raw material by an injection molding method, an injection compression molding method, an extrusion molding method, a blow molding method, a press molding method, a vacuum molding method, an expansion molding method, or the like. In particular, the molded body is preferably produced through use of the resultant pellet by an injection molding method or an injection compression molding method.

A method of producing the molded body is preferably a method including a step of subjecting the resin composition comprising the aromatic polycarbonate resin to injection molding under the conditions of a cylinder temperature of 220° C. or more and 300° C. or less and a retention time of 60 seconds or more and 2,000 seconds or less.

The molded body of the present invention can be suitably used in, for example, exterior and internal parts for parts for electrical and electronic equipment, such as a television, a radio, a camera, a video camera, an audio player, a DVD player, an air conditioner, a cellular phone, a smartphone, a transceiver, a display, a computer, a tablet terminal, portable game equipment, stationary game equipment, wearable electronic equipment, a register, an electronic calculator, a copying machine, a printer, a facsimile, a communication base station, a battery, or a robot, exterior and internal parts for an automobile, a railway vehicle, a ship, an aircraft, equipment for space industry, or medical equipment, and a part for a building material.

Among them, a part for a lighting tool for a vehicle, such as an automobile and a motorcycle, is suitable, and an internal part for the lighting tool for a vehicle is particularly preferred. Preferred examples of the lighting tool for a vehicle include a front lamp for a vehicle, a back lamp for a vehicle, a communication lamp for a vehicle exterior, a light for a vehicle interior (ambient lamp), and a lighting tool for a DRL.

### EXAMPLES

The present invention is described in more detail below by way of Examples, but the present invention is not limited to these Examples.

Respective components used in Examples and Comparative Examples are as described below.

### <Aromatic Polycarbonate Resin (A)>

(A-1): “TARFLON FN1300” (manufactured by Formosa Idemitsu Petrochemical Corporation, bisphenol A polycarbonate resin, viscosity-average molecular weight (Mv)=11,500)
(A-2): “TARFLON FN1500” (manufactured by Formosa Idemitsu Petrochemical Corporation, bisphenol A polycarbonate resin, viscosity-average molecular weight (Mv)=14,400)
(A-3): “TARFLON FN1700” (manufactured by Formosa Idemitsu Petrochemical Corporation, bisphenol A polycarbonate resin, viscosity-average molecular weight (Mv)=17,700)

### <Inorganic Particles (B)>

(B-1): “TTO-55 (A)” (manufactured by Ishihara Sangyo Kaisha Ltd., rutile-type titanium oxide, surface-treated with aluminum hydroxide, average particle diameter: 0.04 μm, specific surface area: 35.97 m²/g)
(B-2): “CR-60” (manufactured by Ishihara Sangyo Kaisha Ltd., rutile-type titanium oxide, surface-treated with aluminum hydroxide, average particle diameter: 0.21 μm, specific surface area: 6.85 m²/g)
(B-3): “CR-50” (manufactured by Ishihara Sangyo Kaisha Ltd., rutile-type titanium oxide, surface-treated with aluminum hydroxide, average particle diameter: 0.25 μm, specific surface area: 5.76 m²/g)
(B-4): “CR-58” (manufactured by Ishihara Sangyo Kaisha Ltd., rutile-type titanium oxide, surface-treated with aluminum hydroxide, average particle diameter: 0.28 μm, specific surface area: 5.14 m²/g)
(B-5): “R-38L” (manufactured by Sakai Chemical Industry Co., Ltd., rutile-type titanium oxide, surface-treated with aluminum hydroxide, average particle diameter: 0.40 μm, specific surface area: 3.60 m²/g)
(B-6): “PT-301” (manufactured by Ishihara Sangyo Kaisha Ltd., rutile-type titanium oxide, non-surface-treated, average particle diameter: 0.25 μm, specific surface area: 5.76 m²/g)
(B-7): “PT-401” (manufactured by Ishihara Sangyo Kaisha Ltd., rutile-type titanium oxide, non-surface-treated, average particle diameter: 0.07 μm, specific surface area: 20.55 m²/g)
(B-8): “PC-3” (manufactured by Ishihara Sangyo Kaisha Ltd., rutile-type titanium oxide, surface-treated with aluminum hydroxide, silicon dioxide, and methylhydrogen polysiloxane, average particle diameter: 0.21 μm, specific surface area: 6.85 m²/g)

### (Method of Measuring Average Particle Diameter)

A 50% cumulative particle diameter (D₅₀) was measured as an average particle diameter as described below. Platinum (Pt) was used as a target, and the inorganic particles (B) were subjected to sputtering treatment using a sputtering apparatus for a coating time of 30 seconds. An image of the inorganic particles (B) subjected to the sputtering treatment described above was taken with a scanning electron microscope (“Regulus 8200”, manufactured by Hitachi High-Tech Corporation), and the obtained image was analyzed with image analysis software (“Image-Pro Plus”, manufactured by Media Cybernetics, Inc.). A value obtained by dividing the sum of the long diameter and short diameter of an inorganic particle by 2 was adopted as a particle diameter. Thus, the particle diameter was determined. Particle diameters of 100 or more inorganic particles were randomly measured by the same method, and a value calculated as an average thereof was adopted as the average particle diameter.

### (Method of Measuring Specific Surface Area)

A specific surface area is a value measured by a BET method using a specific surface area-measuring apparatus in conformity with JIS Z 8830:2013.

### <Liquid Oil Component (C)>

(C-1): “Diana Process Oil PW-32” (manufactured by Idemitsu Kosan Co., Ltd., paraffin-based process oil (liquid paraffin), kinematic viscosity at 40° C.: 31 cSt)
(C-2): “Diana Process Oil PW-380” (manufactured by Idemitsu Kosan Co., Ltd., paraffin-based process oil (liquid paraffin), kinematic viscosity at 40° C.: 409 cSt)
(C-3): “Diana Process Oil NS-100” (manufactured by Idemitsu Kosan Co., Ltd., naphthene-based process oil, kinematic viscosity at 40° C.: 95 cSt)
(C-4): “Diana Process Oil AC-460” (manufactured by Idemitsu Kosan Co., Ltd., aromatic process oil, kinematic viscosity at 40° C.: 460 cSt)
(C-5): “KF-96-10cs” (manufactured by Shin-Etsu Chemical Co., Ltd., dimethyl silicone oil, kinematic viscosity at 40° C.: 8 cSt to 10 cSt)
(C-6): “KF-96-100cs” (manufactured by Shin-Etsu Chemical Co., Ltd., dimethyl silicone oil, kinematic viscosity at 40° C.: 80 cSt to 95 cSt)
(C-7): “KF-96-1000cs” (manufactured by Shin-Etsu Chemical Co., Ltd., dimethyl silicone oil, kinematic viscosity at 40° C.: 800 cSt to 930 cSt)

### <Antioxidant (D)>

(D-1): “ADK STAB PEP-36” (manufactured by ADEKA Corporation, bis(2,6-di-tert-butyl-4-methylphenyl) pentaerythritol-diphosphite)
(D-2): “ADK STAB 2112” (manufactured by ADEKA Corporation, tris(2,4-di-tert-butylphenyl) phosphite)
(D-3): “Doverphos S-9228PC” (manufactured by Dover Chemical Corporation, bis(2,4-dicumylphenyl) pentaerythritol diphosphite)
(D-4): “Sumilizer GP” (manufactured by Sumitomo Chemical Company, Limited, 6-[3-(3-t-butyl-4-hydroxy-5-methylphenyl) propoxy]-2,4,8,10-tetra-t-butyldibenz[d,f] [1,3,2] dioxaphosphepin)

### Examples 1 to 29 and Comparative Examples 1 to 7

### (1. Production of Resin Composition)

The respective components shown in Tables 1 to 7 were mixed with a twin-screw extruder (“TEM-37SS” manufactured by Toshiba Machine Co., Ltd., L/D=40.5, vented) while its cylinder temperature was set to 260° C. At this time, the inorganic particles (B) were mixed with the liquid oil component (C) in advance, and the mixture was shaken with an ultrasonic oscillator at a frequency of 40 kHz for 5 minutes, and was then mixed in one batch together with any other component.

The resultant mixture was supplied from the main throat portion of the extruder with a metering feeder, and the resin kneaded product was extruded into a strand shape under the conditions of an ejection amount of 40 kg/h and a screw revolution number of 180 rpm. The extrudate was rapidly cooled in a strand bath, and was cut with a strand cutter to provide a pellet-shaped resin composition.

α determined by the following equation 1 and β determined by the following equation 2 are shown in Tables 1 to 7.

$$α = ( {m}_{B} \times {S}_{B} ) / {m}_{C} \qquad Equation 1$$

$$β = {m}_{D} / ( {m}_{B} \times {S}_{B} ) \qquad Equation 2$$

In the equation 1 and the equation 2, m_{B}, S_{B}, m_{C}, and m_{D} are as follows:
m_{B}: part by mass of the inorganic particles (B) with respect to 100 parts by mass of the aromatic polycarbonate resin (A);
S_{B}: specific surface area of the inorganic particles (B);
m_{C}: part by mass of the liquid oil component (C) with respect to 100 parts by mass of the aromatic polycarbonate resin (A); and
m_{D}: part by mass of the antioxidant (D) with respect to 100 parts by mass of the aromatic polycarbonate resin (A).

### (2. Optical Evaluation in Surface Direction)

### [Production of Flat-plate Test Piece]

The pellet-shaped resin composition obtained in the foregoing was molded into a flat-plate test piece measuring 150 mm wide by 150 mm long by 4 mm thick with an injection molding machine (“EC180SX” manufactured by Shibaura Machine Co., Ltd.). Conditions for the molding were set to a cylinder temperature of 260° C. and a die temperature of 80° C.

The resin pellet was dried at 120° C. for 5 hours immediately before the molding because moisture was absorbed by the pellet.

### [Evaluation]

In the flat-plate test piece obtained in the foregoing, light emitted from a molded body in a surface direction was quantitively evaluated with a measurement apparatus illustrated in the FIGURE.

Specifically, light was caused to enter a molded article (flat-plate test piece) 1 from a light incident surface 2, and a light-guiding luminance and a color tone in a surface direction were measured. A black rubber plate was placed on a surface facing the measurement surface of the molded article 1 so as to prevent the reflection of the light, and an LED light source 4 including 30 LED chips 3 (“BRT300BL1”, manufactured by Bright Co., Ltd.) was arranged so as to be adjacent to the light incident surface 2.

An output of the light source was adjusted by setting a voltage value and a current value of a power supply apparatus 5 connected to the LED light source to 32 V and 0.23 A, respectively.

<(1) Luminance (Light-Guiding Length: 25 mm)>

In the flat-plate test piece obtained in the foregoing, a luminance was measured with a luminance colorimeter “CS-1000” (manufactured by Konica Minolta Japan, Inc.) under the condition of a measurement angle of 1°. The results are shown in Tables 1 to 7.

As the value becomes higher, a more excellent surface emission luminance is shown at a portion near the light source.

From the viewpoint of a uniform surface emitting property, a suitable luminance (light-guiding length: 25 mm) in this Example was set to from 1,000 cd/m² to 2,600 cd/m².

<(2) Luminance (Light-Guiding Length: 125 mm)>

In the flat-plate test piece obtained in the foregoing, a luminance was measured with a luminance colorimeter “CS-1000” (manufactured by Konica Minolta Japan, Inc.) under the condition of a measurement angle of 1°. The results are shown in Tables 1 to 7.

As the value becomes higher, a more excellent surface emission luminance is shown at a portion far from the light source.

From the viewpoint of a uniform surface emitting property, a suitable luminance (light-guiding length: 125 mm) in this Example was set to 561 cd/m² or more.

### <(3) Degree of Color Uniformity>

In the flat-plate test piece obtained in the foregoing, a “y” value in a CIE 1931 color space was measured with a luminance colorimeter “CS-1000” (manufactured by Konica Minolta Japan, Inc.) under the condition of a measurement angle of 1°. Measured values at light-guiding lengths of 125 mm and 75 mm were represented by y₁₂₅ and y₇₅, respectively. The degree of color uniformity γ was determined by the equation 3. The results are shown in Tables 1 to 7.

As the degree of color uniformity becomes closer to 1.000, a change in color with the light-guiding length becomes smaller.

$$γ = {y}_{125} / {y}_{75} \qquad Equation 3$$

### (3. Appearance Evaluation)

### [Production of Flat-Plate Test Piece]

The pellet-shaped resin composition obtained in the foregoing was molded into a flat-plate test piece measuring 150 mm wide by 150 mm long by 4 mm thick with an injection molding machine (“EC180SX” manufactured by Shibaura Machine Co., Ltd.). Conditions for the molding were set to a cylinder temperature of 260° C. and a die temperature of 80° C.

In addition, the resin pellet was dried at 120° C. for 5 hours immediately before the molding because the pellet could absorb moisture.

### [Evaluation]

### <Appearance Evaluation>

In the flat-plate test piece obtained in the foregoing, 100 molded bodies were successively molded, and the number of molded bodies each having a silver streak on the appearance thereof at that time was determined. The results are shown in Tables 1 to 7.

As the number of silver streaks becomes smaller, the appearance of the molded body becomes more excellent.
1: 0 to 2
2: 3 to 8
3: 9 to 14
4: 15 to 19
5: 20 or more

TABLE 1

| | | | Com- | | | | | | Com- | |
|---|---|---|---|---|---|---|---|---|---|---|
| | | | parative | | | | | | parative | |
| | | | Example | Example | Example | Example | Example | Example | Example | Example |
| | | | 1 | 1 | 2 | 3 | 4 | 5 | 2 | 6 |
| Aromatic | A-2 | Part(s) | 100 | 100 | 100 | 100 | 100 | 100 | 100 | 100 |
| polycarbonate | | by mass | | | | | | | | |
| resin (A) | | | | | | | | | | |
| Inorganic | B-1 | | 0.0005 | | | | | | | |
| particles (B) | B-2 | | | 0.0005 | | | | | | |
| | B-3 | | | | 0.0005 | | | | | |
| | B-4 | | | | | 0.0005 | | | | |
| | B-5 | | | | | | 0.0005 | | | |
| | B-6 | | | | | | | 0.0005 | | |
| | B-7 | | | | | | | | 0.0005 | |
| | B-8 | | | | | | | | | 0.0005 |
| Liquid oil | C-3 | | 0.1 | 0.1 | 0.1 | 0.1 | 0.1 | 0.1 | 0.1 | 0.1 |
| component | | | | | | | | | | |
| (C) | | | | | | | | | | |
| Antioxidant | D-3 | | 0.03 | 0.03 | 0.03 | 0.03 | 0.03 | 0.03 | 0.03 | 0.03 |
| (D) | | | | | | | | | | |
| α | | [m²/g] | 0.180 | 0.034 | 0.029 | 0.026 | 0.018 | 0.029 | 0.103 | 0.034 |
| β | | [g/m²] | 1.7 | 8.8 | 10.4 | 11.7 | 16.7 | 10.4 | 2.9 | 8.8 |
| Optical | Light-guiding | [cd/m²] | 212 | 734 | 682 | 713 | 703 | 694 | 232 | 578 |
| evaluation | luminance | | | | | | | | | |
| in surface | (125 mm) | | | | | | | | | |
| direction | Light-guiding | [cd/m²] | 523 | 1,093 | 1,421 | 1,207 | 1,219 | 1,434 | 533 | 1,589 |
| | luminance | | | | | | | | | |
| | (25 mm) | | | | | | | | | |
| | Degree | [—] | 1.111 | 1.100 | 1.044 | 1.025 | 1.042 | 1.040 | 1.086 | 1.077 |
| | of color | | | | | | | | | |
| | uniformity | | | | | | | | | |
| Appearance | Silver | [1 to 5] | 2 | 2 | 2 | 2 | 2 | 3 | 3 | 3 |
| evaluation | evaluation | | | | | | | | | |

TABLE 2

| | | | Com- | | | | | | | Com- | Com- |
|---|---|---|---|---|---|---|---|---|---|---|---|
| | | | parative | | | | | | | parative | parative |
| | | | Example | Example | Example | Example | Example | Example | Example | Example | Example |
| | | | 3 | 7 | 8 | 2 | 9 | 10 | 11 | 4 | 5 |
| Aromatic | A-2 | Part(s) | 100 | 100 | 100 | 100 | 100 | 100 | 100 | 100 | 100 |
| polycarbonate | | by mass | | | | | | | | | |
| resin (A) | | | | | | | | | | | |
| Inorganic | B-3 | | 0.000005 | 0.0001 | 0.0003 | 0.0005 | 0.0006 | 0.0008 | 0.001 | 0.002 | 0.005 |
| particles (B) | | | | | | | | | | | |
| Liquid oil | C-3 | | 0.1 | 0.1 | 0.1 | 0.1 | 0.1 | 0.1 | 0.1 | 0.1 | 0.01 |
| component | | | | | | | | | | | |
| (C) | | | | | | | | | | | |
| Antioxidant | D-3 | | 0.03 | 0.03 | 0.03 | 0.03 | 0.03 | 0.03 | 0.03 | 0.03 | 0.03 |
| (D) | | | | | | | | | | | |
| α | | [m²/g] | 0.000 | 0.006 | 0.017 | 0.029 | 0.036 | 0.046 | 0.058 | 0.115 | 2.878 |
| β | | [g/m²] | 1,042.5 | 52.1 | 17.4 | 10.4 | 8.3 | 6.5 | 5.2 | 2.6 | 1.0 |
| Optical | Light- | [cd/m²] | 322 | 566 | 612 | 682 | 703 | 651 | 632 | 521 | 301 |
| evaluation | guiding | | | | | | | | | | |
| in surface | luminance | | | | | | | | | | |
| direction | (125 mm) | | | | | | | | | | |
| | Light- | [cd/m²] | 1,342 | 1,412 | 1,492 | 1,421 | 1,687 | 2,160 | 2,210 | 2,832 | 3,031 |
| | guiding | | | | | | | | | | |
| | luminance | | | | | | | | | | |
| | (25 mm) | | | | | | | | | | |
| | Degree of | [—] | 1.032 | 1.035 | 1.038 | 1.044 | 1.047 | 1.053 | 1.055 | 1.078 | 1.137 |
| | color | | | | | | | | | | |
| | uniformity | | | | | | | | | | |
| Appearance | Silver | [1 to 5] | 2 | 2 | 2 | 2 | 2 | 2 | 2 | 2 | 3 |
| evaluation | evaluation | | | | | | | | | | |

TABLE 3

| | | | Comparative | | | | Comparative |
|---|---|---|---|---|---|---|---|
| | | | Example | Example | Example | Example | Example |
| | | | 6 | 12 | 2 | 13 | 7 |
| Aromatic polycarbonate | A-2 | Part(s) | 100 | 100 | 100 | 100 | 100 |
| resin (A) | | by mass | | | | | |
| Inorganic particles (B) | B-3 | | 0.0005 | 0.0005 | 0.0005 | 0.0005 | 0.0005 |
| Liquid oil component (C) | C-3 | | 0.02 | 0.05 | 0.1 | 0.25 | 1 |
| Antioxidant (D) | D-3 | | 0.03 | 0.03 | 0.03 | 0.03 | 0.03 |
| α | | [m²/g] | 0.144 | 0.058 | 0.029 | 0.012 | 0.003 |
| β | | [g/m²] | 10.4 | 10.4 | 10.4 | 10.4 | 10.4 |
| Optical evaluation in | Light-guiding | [cd/m²] | 547 | 652 | 682 | 639 | 624 |
| surface direction | luminance (125 mm) | | | | | | |
| | Light-guiding | [cd/m²] | 973 | 1,498 | 1,421 | 1,652 | 1,732 |
| | luminance (25 mm) | | | | | | |
| | Degree of color | [—] | 1.036 | 1.032 | 1.044 | 1.050 | 1.056 |
| | uniformity | | | | | | |
| Appearance evaluation | Silver evaluation | [1 to 5] | 2 | 2 | 2 | 3 | 4 |

TABLE 4

| | | | Example | Example | Example | Example | Example | Example | Example |
|---|---|---|---|---|---|---|---|---|---|
| | | | 14 | 15 | 2 | 16 | 17 | 18 | 19 |
| Aromatic | A-2 | Part(s) | 100 | 100 | 100 | 100 | 100 | 100 | 100 |
| polycarbonate | | by mass | | | | | | | |
| resin (A) | | | | | | | | | |
| Inorganic | B-3 | | 0.0005 | 0.0005 | 0.0005 | 0.0005 | 0.0005 | 0.0005 | 0.0005 |
| particles (B) | | | | | | | | | |
| Liquid oil | C-1 | | 0.1 | | | | | | |
| component (C) | C-2 | | | 0.1 | | | | | |
| | C-3 | | | | 0.1 | | | | |
| | C-4 | | | | | 0.1 | | | |
| | C-5 | | | | | | 0.1 | | |
| | C-6 | | | | | | | 0.1 | |
| | C-7 | | | | | | | | 0.1 |
| Antioxidant (D) | D-3 | | 0.03 | 0.03 | 0.03 | 0.03 | 0.03 | 0.03 | 0.03 |
| α | | [m²/g] | 0.029 | 0.029 | 0.029 | 0.029 | 0.029 | 0.029 | 0.029 |
| β | | [g/m²] | 10.4 | 10.4 | 10.4 | 10.4 | 10.4 | 10.4 | 10.4 |
| Optical | Light-guiding luminance | [cd/m²] | 602 | 623 | 682 | 590 | 588 | 713 | 570 |
| evaluation | (125 mm) | | | | | | | | |
| in surface | Light-guiding luminance | [cd/m²] | 1,220 | 1,487 | 1,421 | 1,286 | 1,532 | 1,623 | 1,274 |
| direction | (25 mm) | | | | | | | | |
| | Degree of color uniformity | [—] | 1.044 | 1.047 | 1.044 | 1.047 | 1.059 | 1.022 | 1.038 |
| Appearance | Silver evaluation | [1 to 5] | 3 | 2 | 2 | 2 | 3 | 2 | 3 |
| evaluation | | | | | | | | | |

TABLE 5

| | | | Example | Example | Example | Example |
|---|---|---|---|---|---|---|
| | | | 20 | 21 | 2 | 22 |
| Aromatic polycarbonate | A-2 | Part(s) | 100 | 100 | 100 | 100 |
| resin (A) | | by mass | | | | |
| Inorganic particles (B) | B-3 | | 0.0005 | 0.0005 | 0.0005 | 0.0005 |
| Liquid oil component (C) | C-3 | | 0.1 | 0.1 | 0.1 | 0.1 |
| Antioxidant (D) | D-1 | | 0.03 | | | |
| | D-2 | | | 0.03 | | |
| | D-3 | | | | 0.03 | |
| | D-4 | | | | | 0.03 |
| α | | [m²/g] | 0.029 | 0.029 | 0.029 | 0.029 |
| β | | [g/m²] | 10.4 | 10.4 | 10.4 | 10.4 |
| Optical evaluation in | Light-guiding | [cd/m²] | 698 | 678 | 682 | 683 |
| surface direction | luminance (125 mm) | | | | | |
| | Light-guiding | [cd/m²] | 1,434 | 1,403 | 1,421 | 1,439 |
| | luminance (25 mm) | | | | | |
| | Degree of color | [—] | 1.053 | 1.056 | 1.044 | 1.056 |
| | uniformity | | | | | |
| Appearance evaluation | Silver evaluation | [1 to 5] | 2 | 2 | 2 | 2 |

TABLE 6

| | | | Example | Example | Example | Example | Example | Example |
|---|---|---|---|---|---|---|---|---|
| | | | 23 | 24 | 2 | 25 | 26 | 27 |
| Aromatic polycarbonate | A-2 | Part(s) | 100 | 100 | 100 | 100 | 100 | 100 |
| resin (A) | | by mass | | | | | | |
| Inorganic particles (B) | B-3 | | 0.0005 | 0.0005 | 0.0005 | 0.0005 | 0.0005 | 0.0005 |
| Liquid oil component (C) | C-3 | | 0.1 | 0.1 | 0.1 | 0.1 | 0.1 | 0.1 |
| Antioxidant (D) | D-3 | | 0.005 | 0.01 | 0.03 | 0.05 | 0.1 | 0.5 |
| α | | [m²/g] | 0.029 | 0.029 | 0.029 | 0.029 | 0.029 | 0.029 |
| β | | [g/m²] | 1.7 | 3.5 | 10.4 | 17.4 | 34.8 | 173.8 |
| Optical evaluation in | Light-guiding | [cd/m²] | 690 | 680 | 682 | 679 | 683 | 674 |
| surface direction | luminance (125 mm) | | | | | | | |
| | Light-guiding | [cd/m²] | 1,437 | 1,416 | 1,421 | 1,422 | 1,430 | 1,399 |
| | luminance (25 mm) | | | | | | | |
| | Degree of color | [—] | 1.089 | 1.065 | 1.044 | 1.051 | 1.047 | 1.031 |
| | uniformity | | | | | | | |
| Appearance evaluation | Silver evaluation | [1 to 5] | 2 | 2 | 2 | 2 | 2 | 2 |

TABLE 7

| | | | Example | Example | Example |
|---|---|---|---|---|---|
| | | | 28 | 2 | 29 |
| Aromatic | A-1 | Part(s) | 100 | | |
| polycarbonate | A-2 | by mass | | 100 | |
| resin (A) | A-3 | | | | 100 |
| Inorganic | B-3 | | 0.0005 | 0.0005 | 0.0005 |
| particles (B) | | | | | |
| Liquid oil | C-3 | | 0.1 | 0.1 | 0.1 |
| component (C) | | | | | |
| Antioxidant (D) | D-3 | | 0.03 | 0.03 | 0.03 |
| α | α | [m²/g] | 0.029 | 0.029 | 0.029 |
| β | β | [g/m²] | 10.4 | 10.4 | 10.4 |
| Optical | Light-guiding | [cd/m²] | 679 | 682 | 663 |
| evaluation | luminance (125 mm) | | | | |
| in surface | Light-guiding | [cd/m²] | 1,559 | 1,421 | 1,586 |
| direction | luminance (25 mm) | | | | |
| | Degree of color | [−] | 1.054 | 1.044 | 1.037 |
| | uniformity | | | | |
| Appearance | Silver evaluation | [1 to 5] | 3 | 2 | 1 |
| evaluation | | | | | |

### REFERENCE SIGNS LIST

1 molded article (flat-plate test piece)
2 light incident surface
3 LED chip
4 LED light source
5 power supply apparatus

1. A polycarbonate-based resin composition, comprising:
an aromatic polycarbonate resin (A);
inorganic particles (B); and
a liquid oil component (C),
wherein the inorganic particles (B) have an average particle diameter of from 0.1 μm to 1 μm,
wherein a content of the inorganic particles (B) is from 0.00001 part by mass to 0.001 part by mass with respect to 100 parts by mass of the aromatic polycarbonate resin (A), and
wherein, when a part by mass of the inorganic particles (B) with respect to 100 parts by mass of the aromatic polycarbonate resin (A) is represented by m_{B}, a specific surface area of the inorganic particles (B) is represented by S_{B} (m²/g), and a part by mass of the liquid oil component (C) with respect to 100 parts by mass of the aromatic polycarbonate resin (A) is represented by m_{C}, α determined by the following equation 1 is more than 0.005 and less than 0.1.
$$α = ( {m}_{B} \times {S}_{B} ) / {m}_{C} \qquad Equation 1$$

2. The polycarbonate-based resin composition according to claim 1, wherein the inorganic particles (B) are titanium oxide.

3. The polycarbonate-based resin composition according to claim 1, further comprising an antioxidant (D),
wherein the antioxidant (D) comprises at least one selected from the group consisting of: a phosphorus-based antioxidant; and a phenol-based antioxidant.

4. The polycarbonate-based resin composition according to claim 3, wherein a content of the antioxidant (D) is from 0.001 part by mass to 1.0 part by mass with respect to 100 parts by mass of the aromatic polycarbonate resin (A).

5. The polycarbonate-based resin composition according to claim 3, wherein, when a part by mass of the antioxidant (D) with respect to 100 parts by mass of the aromatic polycarbonate resin (A) is represented by m_{D}, β determined by the following equation 2 is more than 2.95 and less than 200:
$$β = {m}_{D} / ( {m}_{B} \times {S}_{B} ) \qquad Equation 2$$
wherein m_{B} and S_{B} are the same as those described above.

6. The polycarbonate-based resin composition according to claim 1, wherein the aromatic polycarbonate resin (A) has a viscosity-average molecular weight of from 12,500 to 30,500.

7. The polycarbonate-based resin composition according to claim 1, wherein the liquid oil component (C) comprises at least one selected from the group consisting of: a paraffin-based process oil, a naphthene-based process oil, an aromatic process oil, and a silicone oil.

8. The polycarbonate-based resin composition according to claim 1, wherein the liquid oil component (C) is liquid at normal temperature, and has a kinematic viscosity at 40° C. of from 30 cSt to 1,000 cSt.

9. A pellet, comprising the polycarbonate-based resin composition of claim 1.

10. A molded body, comprising the polycarbonate-based resin composition of claim 1.
